(19) United States
(12) Patent Application Publication
(10) Pub. No.: US 2002/0112170 A1
(43) Pub. Date: Aug. 15, 2002

(54) Method and apparatus for using one financial instrument to authenticate a user for accessing a second financial instrument

(76) Inventors: James M. Foley, Peoria, AZ (US); Rick D. Johnson, Peoria, AZ (US); Anant Nambiar, New Rochelle, NY (US)

Correspondence Address: SNELL & WILMER L.L.P., One Arizona Center, 400 East Van Buren, Phoenix, AZ, 85004-2202, US

(21) Appl. No.: 10/038,024

(22) Filed: Jan. 3, 2002

Related U.S. Application Data
(60) Provisional application No. 60/259,607, filed on Jan. 3, 2001.

(51) Int. Cl. H04K 1/00; H04L 9/00

(52) U.S. Cl. 713/184

(57) ABSTRACT

The present invention includes a system and method for using a first financial instrument to facilitate access to a second financial instrument. A method of authentication for facilitating activation of the first financial instrument is identified. The method of authentication is validated in connection with the first financial instrument. The first financial instrument is used to authenticate a user in connection with gaining access to a second financial instrument. In the example of a smart card and PIN authentication method, a smart card and PIN may be used to authorize access to a brokerage account. Thus, the first financial instrument may be used to authenticate the user in connection with gaining access to the second financial instrument.

### RELATED APPLICATIONS

This patent application claims priority to, and the benefit of, the U.S. provisional patent application entitled “CROSS FINANCIAL INSTRUMENT AUTHENTICATION AND AUTHORIZATION” filed on Jan. 3, 2001 as U.S. Serial No. 60/259,607, which is hereby incorporated by reference.

### FIELD OF INVENTION

The present invention generally relates to using a financial instrument to gain access to a number of differing restricted services and/or products, and more particularly, to a system and method for using a first financial instrument to authenticate a user for allowing access to a number of differing restricted services and/or products associated with a second financial instrument.

### BACKGROUND OF THE INVENTION

A financial instrument may include a credit card, a smart card, a stored value card, a stored value product, a personal digital assistant, a cellular telephone, an electronic traveler's check, an on-line financial service, an automated teller machine (ATM), and/or an ATM card. Financial instruments are typically used for their intended purpose, such as, for example, making a purchase with a credit card. Moreover, many consumers, for example, have discovered the convenience and economy of using a financial instrument for on-line electronic services (e.g., purchasing on-line, financial services on-line, and the like). A user of a financial instrument is often a consumer (e.g., desiring to purchase and/or sell a product, service or other item of commerce). A user may also be a merchant, a distributor, a supplier, a seller, and/or any entity desiring to gain access to a restricted service or location.

In a typical Internet transaction, a consumer generally identifies goods and/or services for purchase by viewing an online advertisement such as a hypertext markup language (HTML) document provided via a World Wide Web (WWW) browser. Payment typically occurs in various ways using a financial instrument, such as, for example, via a charge card number that is provided via a secure channel such as a secure sockets layer (SSL) connection that is established between the consumer and the merchant.

Because of the high incidence of fraud in Internet transactions, most charge card issuers consider network transactions to be “Card Not Present” transactions that are often subject to a higher discount rate. Stated another way, because of the increased risk from “Card Not Present” transactions, most charge card issuers charge the merchant a higher rate for accepting card numbers via electronic means than would be charged if the card were physically presented to the merchant. To improve the security deficiencies inherent in transporting charge card numbers over unsecure networks, many have suggested the use of “smart cards”. Smartcards typically include an integrated circuit chip having a microprocessor and memory for storing data directly on the card. The data can correspond to a cryptographic key, for example, or to an electronic purse that maintains an electronic value of currency. Many smart card schemes have been suggested in the prior art, but these typically exhibit a marked disadvantage in that they are non-standard and typically require the merchants to obtain new, proprietary software for their Web storefronts to accept the smart card transactions. Moreover, the administration costs involved with assigning and maintaining the cryptographic information associated with smart cards have been excessive to date. Additional information relating to smart card and smart card reader payment technology is disclosed in U.S. patent application Ser. No. 09/952,490 filed on Sep. 12, 2001; U.S. patent application Ser. No. 60/232,040, filed on Sep. 12, 2000; and U.S. Pat. Nos. 5,742,845; 5,898,838; and 5,905,908, owned by Datascape; which are hereby incorporated by reference.

Existing digital wallet technology is used to provide a means for users to utilize transaction card products (e.g., credit cards, charge cards, debit cards, smart cards, account numbers, and the like) to pay for products and services on-line. More details related to digital wallets and smart card technology can be found in U.S. patent application Ser. No. 09/653,837 entitled “Transaction Card” which was filed on Sep. 1, 2000; U.S. patent application Ser. No. 09/652,899 entitled “Method and Apparatus For Conducting Electronic Transactions” filed on Aug. 31, 2000; and U.S. patent application Ser. No. 09/734,098 entitled “Method and Apparatus For Illuminating a Transaction Card” filed Dec. 11, 2000, all of which are herein incorporated by reference. In general, digital wallets are tools which store personal information (name, address, charge card number, credit card number, etc.) in order to facilitate electronic commerce or other network interactions. The personal information can be stored on a general server or at a client location (Personal Computer (PC) or smart card) or on a hybrid of both a general server and a client server. Presently, the digital wallet general server is typically comprised of a Web server and a database server which centrally houses the user's personal and credit card information, shopping preferences and profiles of on-line merchants.

A digital wallet preferably performs functions such as single sign on/one password, automatic form filling of check out pages, one or two click purchasing, personalization of web sites, on-line order and delivery tracking, itemized electronic receipts, and customized offers and promotions based upon spending patterns and opt-ins. More particularly, a one-click purchase activates the wallet and confirms the purchase at the same time. A two-click check out first activates the wallet, then the second click confirms the purchase. In use, the wallet bookmark is typically clicked by the user and an SSL session is established with the Wallet server. A browser plug-in is executed and the user supplies a user identification and password or smart card for authentication in order to gain access to the wallet data. When shopping at an on-line merchant, the appropriate wallet data is transferred from the wallet server to the merchant's Web server.

For more information on digital wallet systems, loyalty systems, transaction systems, electronic commerce systems, see, for example, the Shop AMEX™ system as disclosed in U.S. Patent Application Serial No. 60/230,190 filed Sep. 5, 2000; the MR as Currency™ and Loyalty Rewards Systems as disclosed in U.S. patent application Ser. No. 09/834,478 filed on Apr. 13, 2001; U.S. Patent Application Serial No. 60/197,296 filed on Apr. 14, 2000; U.S. Patent Application Serial No. 60/200,492 filed Apr. 28, 2000; U.S. Patent Application Serial No. 60/201,114 filed May 2, 2000; a digital wallet system disclosed in U.S. patent application Ser. No. 09/652,899 filed Aug. 31, 2000; a stored value card as disclosed in U.S. patent application Ser. No. 09/241,188 filed on Feb. 1, 1999; a system for facilitating transactions using secondary transaction numbers disclosed in U.S. patent application Ser. No. 09/800,461 filed on Mar. 7, 2001; U.S. Patent Application Serial No. 60/187,620 filed Mar. 7, 2000; U.S. Patent Application Serial No. 60/200,625 filed Apr. 28, 2000; and U.S. Patent Application Serial No. 60/213,323 filed May 22, 2000; all of which are herein incorporated by reference. Other examples of an online membership reward systems are disclosed in U.S. Pat. No. 5,774,870, issued on Jun. 30, 1998, and U.S. Pat. No. 6,009,412, issued on Dec. 29, 1999, both of which are hereby incorporated by reference.

In addition to security issues in transporting charge card numbers over insecure networks, users oftentimes desire access to differing services and/or products using a single financial instrument. For example, it would be desirable to use one financial to identify a user, verify information, and allow access to a restricted service or location. Existing systems, however, are limited to using a financial instrument only for its intended purpose (i.e., using a credit card to make purchases). Thus, a system and method for using one financial instrument to authenticate a second financial instrument is desirable.

### SUMMARY OF THE INVENTION

The present invention includes a system and method for using a first financial instrument as authentication to gain access to a second financial instrument. A method of authentication is identified for activating the first financial instrument, then the first financial instrument is used to verify that the method of authentication allows access to a second financial instrument. If the method of authentication allows access to the second financial instrument, then the first financial instrument may be used to authenticate a user for accessing the second financial instrument, such that authenticating the user allows access to the second financial instrument.

### BRIEF DESCRIPTION OF THE DRAWINGS

The subject invention will hereinafter be described in the context of the appended drawing figures, wherein like numerals denote like elements, and:

FIG. 1 illustrates a flowchart for a method for using a first financial instrument to access a second financial instrument in accordance with an exemplary embodiment of the present invention;

FIG. 2 illustrates a flowchart for a method for a host to determine the minimum security level for authentication of more than one financial instrument based on predetermined characteristics in accordance with an exemplary embodiment of the present invention; and

FIG. 3 illustrates a communication system for using a first financial instrument to access a second financial instrument in accordance with an exemplary embodiment of the present invention.

### DETAILED DESCRIPTION OF EXEMPLARY EMBODIMENTS

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices or processes. Similarly, the software elements of the present invention may be implemented with any programming or scripting language such as Basic, C, C++, Java, COBOL, assembler, PERL, with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to validate data with a user-side scripting language, such as JavaScript, VBScript or the like.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

To simplify the description of the exemplary embodiments, the present invention is described as pertaining to a system of electronic commerce, e.g., smart card transactions running over the Internet. It will be appreciated, however, that many applications of the present invention could be formulated. For example, the system could be used to access various financial services, to access any financial instrument, to use any financial instrument to access any service, to activate a passcode system, to access a retricted service or network, or for any other purpose. The system may also be used to access on-line services, kiosk services, Point of Sale (POS) terminals, Automatic Teller Machines (ATMs), and/or the like.

Users desire financial instruments having multipurpose uses. For example, a user may desire using her smart card to access her brokerage account. In such a transaction, activating the user's smart card will also facilitate allowing access to the user's brokerage account. In this way, the authentication by a first financial instrument would be used to facilitate the authentication of a user in connection with accessing a second financial instrument. Accordingly, the user may access differing services and/or products using one financial instrument. The user typically includes a consumer desiring to access an on-line service, access a restricted area, purchase and/or sell a product, service or other item of commerce, otherwise transact in commerce, and/or communicate with another entity. The user may alternatively include a merchant, a distributor, a supplier, a person, an entity, software, hardware and/or the like desiring to transact or otherwise communicate with a consumer, a merchant, a distributor, a supplier, a person, an entity, software, hardware and/or the like. The user may interact with the system via any input device such as a computing unit, keyboard, mouse, smart card reader, biometric system, kiosk, personal digital assistant, handheld computer (e.g., Palm Pilot®), cellular phone and/or the like. A financial instrument may include a credit card, a smart card, a stored value card, a stored value product, a personal digital assistant, a cellular telephone, an electronic traveler's check, an on-line financial service, a radio frequency enabled payment device, and/or an automated teller machine.

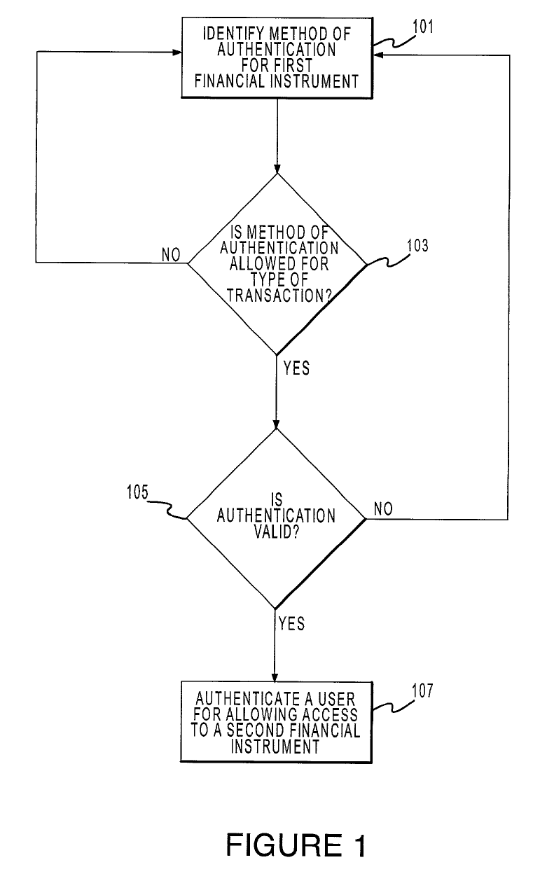

FIG. 1 illustrates a flowchart for an exemplary method for using a first financial instrument to facilitate access to a second financial instrument in accordance with an exemplary embodiment of the present invention. The exemplary method of authentication is identified for the first financial instrument (step 101). For example, a smart card may be used with a computer system to access an on-line financial service. The smart card is inserted into a smart card reader coupled to the computer system, and a check is made to identify the method of authentication (i.e., smart card and PIN) for accessing an on-line financial service. Exemplary methods of authentication include a standard user identification and password, a user identification and pass-phrase, a smart card and PIN, biometric with or without a password (e.g., thumbprint, eye scan, voice recognition), a smart card and digital certificate, a palm pilot and digital certificate, sound verification, radio frequency and password, radio frequency and biometrics, infrared and biometrics, infrared and password, and/or the like. In addition, more than one level of authentication may be used (e.g., an item or device and known information, a smart card and PIN with a digital certificate). Further, more than one authentication method (i.e., any number of authentication methods) may be used depending on the level of security desired for authentication. For example, both the user identification and password and the smart card and PIN authentication methods can be used together for two levels of security for authentication.

A check determines whether the method of authentication is allowed for the type of transaction desired (step 103). When the smart card is inserted into the smart card reader, a check is made to determine whether the method of authentication (i.e., smart card and PIN) is allowed for accessing the on-line financial service. In a charge card website (e.g., www.americanexpress.com), a user identification and password may be used to access the summary of a user's monthly charge card statement. Alternatively, an advanced level of security for authentication, such as a smart card and PIN or a digital certificate on a smart card with a PIN may be used to access a brokerage account. As such, accessing a restricted service, a restricted network, a restricted area, a website, a webpage, a function, and/or an individual application within a website usually includes an authentication method for authorization to gain access.

If the method of authentication is not allowed for using the chosen transaction (e.g., smart card and PIN cannot be used to access the on-line financial service, using user identification and password attempted where smart card and PIN are required, and/or the like), then identification of another method of authentication for the first financial instrument takes place (step 101). If, on the other hand, the method of authentication is allowed for the type of transaction desired, then a check is made to determine whether the authentication method is valid (step 105).

Determining whether the authentication method is valid includes checking to determine if the allowed authentication method is valid for the chosen transaction. If the authentication method is not valid, then another method of authentication is identified (step 101). If the authentication method is valid, then the first financial instrument is used to authenticate a user for accessing the second financial instrument (step 107). For example, a smart card may be used to access an on-line brokerage account, where the first financial instrument is the smart card and the second financial instrument is the on-line brokerage account in this example. If the authentication method (i.e., smart card and PIN, in this example) is valid, then the first financial instrument (i.e., smart card) authenticates a user for accessing the second financial instrument (i.e., the on-line brokerage account). In this way, the smart card facilitates the authorization of access to the on-line brokerage account.

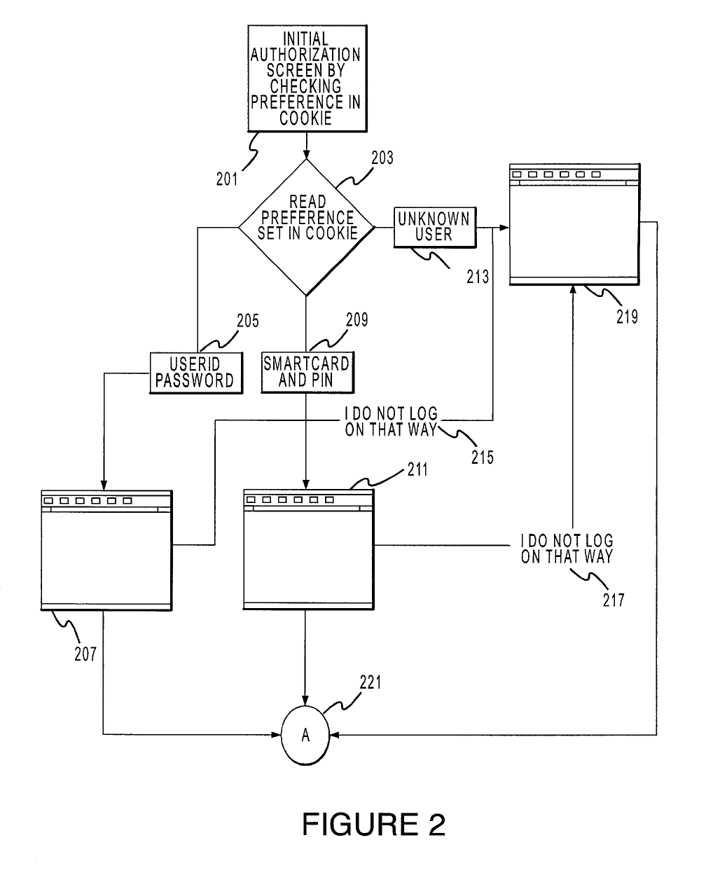

FIG. 2 illustrates an exemplary embodiment of the present invention, where a host facilitates the determination of the minimum security level for authentication of more than one financial instrument based on predetermined characteristics. A host may include one or more of the following: a server, a personal computer, a mainframe, a distributed network (e.g., the internet), a web service, and/or the like. There are many methods that the host may use in order to determine the security level for authentication of the financial instruments. For example, the host may check for a cookie residing on a user's computing unit (step 201). The host may use any other method of identifying the security level for authentication via any identification method. The host reads the preference set in the cookie, where the cookie includes information regarding the minimum level of security for authentication of the first and/or second financial instrument (step 203). In this way, the host may identify the authentication method for the first and/or second financial instrument, if the preference set includes information regarding the minimum level of security for authentication. For example, if the cookie indicates that user identification and password is the authentication method (step 205), then a dialog box requesting a user identification and password is presented to the user via a web page (step 207). If the cookie indicates that smart card and PIN is the authentication method (step 209), then a dialog box requesting a smart card and PIN is presented to the user via a web page (step 211).

If the authentication method is user identification and password, then the preference set indicating the user identification and password method of authentication is retrieved. The preference set may be stored in a database, and the system may use a database call to confirm the method of authentication. If the authentication method is smart card and PIN and/or digital certificate, then the user inputs a PIN for the smart card and a check is made to determine whether the PIN and/or digital certificate associated with the smart card (e.g., in a user Internet account) is valid. Such a check is also via a database call. If the smart card and PIN and/or digital certificate is active, then authentication is valid. On the other hand, if the smart card and PIN and/or digital certificate is not active, then authentication is not valid. A database call may include, e.g., back-up data, tracking information, and/or the like. A database may be any type of database, such as relational, hierarchical, object-oriented, and/or the like. Common database products that may be used to implement each database include DB2 by IBM (White Plains, N.Y.), any of the database products available from Oracle Corporation (Redwood Shores, Calif.), Microsoft SQL Server by Microsoft Corporation (Redmond, Washington), or any other database product. Each database may be organized in any suitable manner, including as data tables or lookup tables.

On the other hand, if the preference set does not include information regarding the minimum level of security for authentication (e.g., the user or authentication method is unknown) (step 213) or the user does not use either of the authentication methods provided by the host (steps 215 and 217), then a dialog box is presented giving the user the option to try another authentication method (step 219). For example, the preference set may not include information on the method of authentication if the computing unit is new to the host, the user is accessing the host from a computing unit different from its usual point of access, a glitch in the host or computing unit, and/or the like.

If the system can authenticate the first financial instrument (e.g., via user identification and password entry or the smart card and PIN entry, in this example), then the first financial instrument may further be used to authenticate a user for gaining access to the second financial instrument (step 221). Accordingly, the first financial instrument is identified, validated, and authorized to authenticate a user for accessing the second financial instrument. Thus, the system allows authentication of the first financial instrument to further authenticate the second financial instrument.

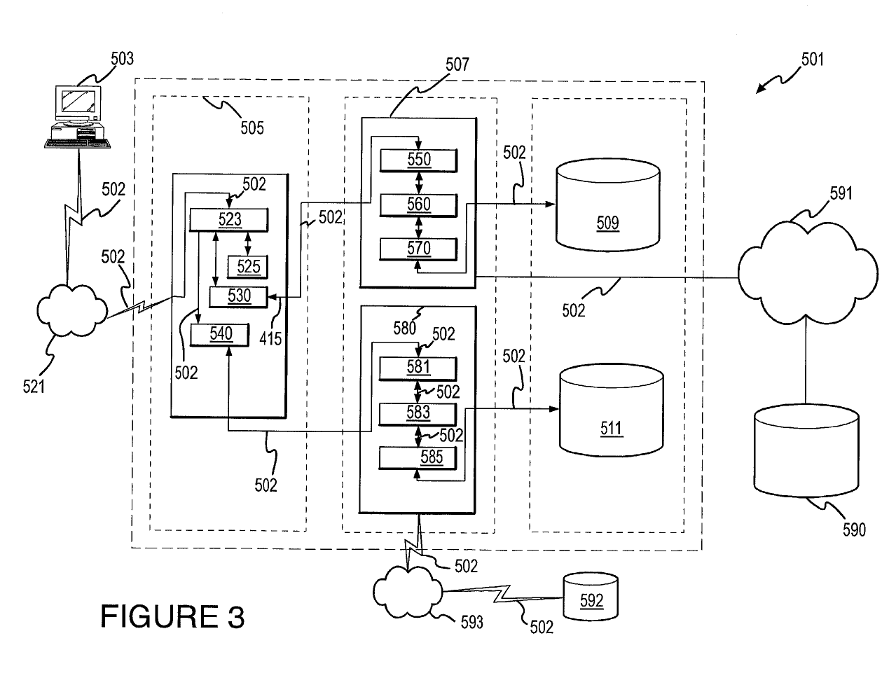

A communication system 501 for using a first financial instrument to authenticate a user in connection with accessing a second financial instrument in accordance with an exemplary embodiment of the present invention is illustrated in FIG. 3. Communication system 501 includes browser 503, web server 505, an application server 507, a security server 580, one or more communication channels 502, and one or more database servers 509, 511. Browser 503 passes input field values, e.g., using https, to web server 505. As such, browser 503 submits data to web server 505 and web server 505 sends the data to application server 507 and/or security server 580. Data from the application server 507 may be stored in and retrieved from one or more database servers 509. Data from the security server 580 may be stored in and retrieved from one or more database servers 511. Browser 503, web server 505, application server 507, security server 580, and/or one or more database servers 509, 511 may transmit the data to each other in XML format, for example, via one or more communication channels 502. Each of browser 503, web server 505, application server 507, security server 580, and/or one or more database servers 509, 511 may transfer the data and/or receive data using https and an XML format.

In such an exemplary embodiment, communication system 501 includes a browser 503 through which a first financial instrument submits data to a web server 505 (e.g., one or more host servers, a network, and/or the like) via one or more communication channels 502. The data includes a request regarding a second financial instrument (e.g., requesting access to a brokerage account). Browser 503 may include a computer, e.g., a smart card reader, a machine containing interface software, and/or the like. Browser 503 may also include a PC, MAC, cell phone, PDA, kiosk containing internet browser software, and/or network user interface software. Web server 505 may include a data center, such as a centralized server with remote fail-over, a distributed data center patterned after a Web Services model, one or more servers configured to receive and respond to requests from browser 503 (e.g., mircocomputer(s), mainframe), and/or the like. Communication between browser 503 and web server 505 may be via one or more communication channels 502 (e.g., an internet service provider, a network 521 (e.g., internet, intranet, extranet, wireless, VPN, Blue Tooth, LAN, WAN), a network interface between a published external access point and a web server, and/or any other means of communication). One or more communication channels 502 may include internal server communication channels that carry data from a port to web server 505 (e.g., an interprocess communication (IPC) channel).

In this manner, browser 503 may submit information in connection with an authentication method for the first financial instrument to web server 505. Web server 505 may also include web server processes 523 (e.g., programs that receive and respond to requests, such as CGIs, Java Servlets, JSP, ASP). Web server processes 523 may communicate with static content 525 (e.g., text, graphics, sound files, video, and/or the like using HTML, WML, MIME defined files, and/or the like) via one or more communication channels 502 (e.g., operating system supported file read on static content, data retrieval from a datastore, and/or the like). Web server processes 523 may also communicate with application data request handler 530 (e.g., Java Servlets, services, daemon processes, linked libraries, and/or the like) to receive and process requests for application (often dynamic) data. In addition, web server processes 523 may communicate with security data request handler 540 (e.g., Java Servlets, services, daemon processes, linked libraries, and/or the like) to receive and process requests for authentication and authorization data.

Web server 505 may communicate with security server 580 having security data request handler 581, security business logic 583, and data request handler 585. Security server 580 may be a microcomputer, a mainframe, and/or the like. Security server 580 can authenticate the first and second financial instruments and authorize transaction requests. For example, security server 580 may identify the method of authentication for the first financial instrument (step 101 of FIG. 1) via security data request handler 581. If the method of authentication is, e.g., smart card and PIN, then such data is passed from browser 503 to web server 505 to security server 580. Security data request handler 581 may receive and process requests for authentication and authorization from security data request handler 540 via one or more communication channels 502. In the example of smart card and PIN, security data request handler 581 receives and processes requests to authenticate the first financial instrument using the smart card and PIN authentication method from security data request handler 540 via one or more communication channels 502. Security data request handler 581 may use Java Servlets, services, daemon, processes, and/or the like.

Security business logic 583 processes authentication and authorization requests by requesting data from one or more database servers 511. For example, security business logic 583 may determine whether the method of authentication is allowed and valid for the desired transaction (steps 103 and 105 of FIG. 1). Security business logic 583 processes the requests based on established rules and returns the request results to security data request handler 581. For example, the established rules may allow the first financial instrument to authenticate a user for gaining access to the second financial instrument (step 107 of FIG. 1). Security business logic 583 may use Java Servlets or programs, linked libraries, and/or the like.

Data request handler 585 receives and processes requests for data from one or more database servers 511. For example, data request handler 585 may redirect requests to other systems (e.g., a system in connection with the second financial instrument). Similar to security data request handler 581, data request handler 585 may use Java Servlets, services, daemon, processes, and/or the like. Data request handler 585 may communicate with one or more database servers 511 via one or more communication channels 502 using JDBC, CICS, LU6.2, socket, and/or the like. One or more database servers 511 may be one or more relational databases, hierarchical databases, flat files, LDAP, and/or the like. Further, one or more database servers 511 may be security data stores, e.g., any data stored to support the security rules.

As discussed above, data request handler 585 may redirect requests to other systems (e.g., a system in connection with the second financial instrument, such as an on-line brokerage account). In this way, security server 580 may communicate with external security stores 592 via one or more communication channels 502, where external security stores 592 may include an on-line brokerage account. External security stores 592 may have a security server (not shown) which communicates with security server 580 in a manner similar to that described with respect to FIGS. 1 and 5 (e.g., similar to steps 101, 103, and 105 of FIG. 1). In this manner, external security stores 592 may have a similar identification and validation system in order to allow access to the second financial instrument (e.g., the on-line brokerage account). For example, the established rules of a security business logic (not shown) of external security stores 592 may return request results to a security data request handler (not shown) of external security stores 592. Of course, the security server of external security stores 592 may be configured in a different manner depending on its own needs.

Once external security stores 592 identifies and validates authentication of the second financial instrument, then the answer to the original request from data request handler 585 is sent. Following that, the first financial instrument may authenticate a user for gaining access to the second financial instrument (step 107 of FIG. 1). In the example of the smart card and PIN for access to an on-line brokerage account, the smart card may be used to authenticate the on-line brokerage account. Thus, authentication of the first fmancial instrument may be used to gain access to the second financial instrument. External security stores 592 may include relational databases, hierarchical databases, flat files, LDAP, and/or the like. Security server 580 and external security stores 592 may communicate via a third party network 593 (e.g., SSL internet, intranet, extranet, VPN, T1, and/or the like). One or more communication channels 502 between third party network 593 and external security stores 592 may be a network interface that provides an interface between a published external access point and external security stores 592, such as multiple interfaces when external security stores 592 is distributed across hosting facilities.

Web server 505 may also communicate the information in connection with an authentication method for the first financial instrument to application server 507 (e.g., one or more servers configured to receive and respond to requests for data from web server 505, such as a microcomputer, a mainframe, and/or the like) via one or more communication channels 502. For example, once security server 580 indicates that the first financial instrument has been authenticated, then web server 505 may further communicate with application server 507. One or more communication channels 502 can use sockets, CORBA, RMI, MQSeries, messaging protocol (e.g., XML, ASN, proprietary), and/or the like. For example, application server 507 may receive data from web server 505, retrieve data from one or more database servers 509, process defined business logic routines, and return data to web server 505.

Application server 507 may include application data request handler 550, application business logic 560, and data request handler 570. Data request handler 550 receives and processes requests for application (often dynamic) data from application data request handler 530. Application data request handler 550 communicates with web server 505 via one or more communication channels 502. Application data request handler 550 may include Java Servlets, services, daemon processes, and/or the like.

Application server 507 may also include application business logic 560 to initiate data requests from one or more database servers 509, 511, manipulate the retrieved data as defined by established rules, and return data to application data request handler 550. Application business logic 560 may communicate with application data request handler 550 via one or more communication channels 502 (e.g., an interprocess communication channel). Application business logic 560 may include Java Servlets or programs, linked libraries, and/or the like.

Application business logic 560 may also communicate the information regarding the authentication method for the first financial instrument to data request handler 570 to receive and process requests from application business logic 560 for data from one or more database servers 509. Communication between data request handler 570 and application business logic 560 may use one or more communication channels 502 (e.g., an interprocess communication channel). Communication between data request handler 570 and one or more database servers 509 may also use one or more communication channels 502 (e.g., JDBC, CICS, LU6.2, socket, and/or the like). Data request handler 570 may include Java Servlets, services, daemon processes, and/or the like. Database servers 509 may include systems of record data stores (e.g., relational databases, hierarchical databases, flat files, LDAP, and/or the like).

Application server 507 may further communicate with external partner stores 590 via one or more communication channels 502, where external partner stores 590 store data. External partner stores 590 may include relational databases, hierarchical databases, flat files, LDAP, and/or the like. Application server 507 and external partner stores 590 may communicate via a third party network 591 (e.g., SSL internet, intranet, extranet, VPN, T1, and/or the like). One or more communication channels 502 between third party network 591 and external partner stores 590 may be a network interface that provides an interface between a published external access point and external partner stores 590, such as multiple interfaces when external partner stores 590 is distributed across hosting facilities.

Thus, communication system 501 includes a system using the first financial instrument to authenticate a user for accessing the second financial instrument. The first financial instrument and communication system 501 may use any suitable communication means (e.g., one or more communication channels 502) to communicate (e.g., exchange data). One or more communication channels 502 may be any type of communication means which provides any form of communication between the various elements (e.g., between browser 503, web server 505, application server 507, security server 580, one or more database servers 509, 511, third party network 591, external partner stores 590, and/or external security stores 592). It will be appreciated, that many applications of the present invention could be formulated. One skilled in the art will appreciate that one or more communication channels 502 may include any system for exchanging data or transacting business, such as any hardware and/or software communication medium (e.g., telephone, modem, digital subscriber line, a global computer network, a wired link, a wireless link, any utility link), the Internet, an intranet, an extranet, WAN, LAN, satellite communications, and/or the like. It is noted that one or more communication channels 502 may be implemented as any type of network, such as open network, secured network, an interactive television (ITV) network. Furthermore, one or more communication channels 502 may be one network or multiple independent networks. The invention could be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, or the like.

Communication system 501 communicates with one or more users by transmitting, transferring, or otherwise communicating with the user(s) via one or more communication channels 502. The computing units used by the user, the system (e.g., communication system 501), and/or the like may be connected with each other via one or more communication channels 502 (e.g., a data communication network). The network may be a public network and assumed to be insecure and open to eavesdroppers. In the illustrated implementation, the network may be embodied as the Internet. In this context, the computers may or may not be connected to the Internet at all times. For instance, the user computer may employ a modem to occasionally connect to the Internet, whereas the system's computing center might maintain a permanent connection to the Internet. Various systems and servers are suitably coupled to the network via data links. A variety of conventional communications media and protocols may be used for data links. For example, a connection to an Internet Service Provider (ISP) over the local loop is typically used in connection with standard modem communication, cable modem, Dish networks, ISDN, Digital Subscriber Line (DSL), or various wireless communication methods. The various systems might also reside within a local area network (LAN) which interfaces to the network via a leased line (T1, D3, etc.). Such communication methods are well known in the art, and are covered in a variety of standard texts. See, e.g., GILBERT HELD, UNDERSTANDING DATA COMMUNICATIONS (1996), which is hereby incorporated by reference.

The system (e.g., communication system 501) may communicate the data to the user using at least one protocol in at least one format. For example, the system may configure the data in a format and communicate the data to the user using a protocol (e.g., using https and XML). In one exemplary embodiment of the present invention, the system and the user may have a predetermined protocol and format in order to facilitate the communication of the data between them.

Exemplary protocols include hyper text transfer protocol (http), secured hyper text transfer protocol (https), file transfer protocol, secure electronic mail, a network, remote method invocation, distributed component object model, enterprise java bean, and/or socket communication. One embodiment of the present invention may be implemented with TCP/IP communications protocols, IPX, Appletalk, IP-6, NetBIOS, OSI or any number of existing or future protocols. For a basic introduction of cryptography, please review a text written by Bruce Schneier which is entitled “Applied Cryptography: Protocols, Algorithms, And Source Code In C,” published by John Wiley & Sons (second edition, 1996), which is hereby incorporated by reference. Specific information related to the protocols, standards, and application software utilized in connection with the Internet may not be discussed herein. For further information regarding such details, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997). All of these texts are hereby incorporated by reference.

Exemplary formats include extensible markup language (XML), name value pair, any custom format, any industry standard format, and/or the like. For example, XML is a markup language for documents including structured information. Structured information includes content (e.g., words, pictures, and/or the like) and some indication of the type of content (e.g., heading, footnote, figure, database table, etc.). In this manner, a markup language can identify structures in a document (e.g., by adding markup to the document). Documents include, for example, traditional documents, vector graphics, electronic commerce transactions, mathematical equations, object meta-data, server Application Programming Interfaces, and/or the like. The XML language (e.g., XML schemas) may describe and constrain the content of XML documents.

In order to further describe the present invention, the following provides further exemplary embodiments for the various elements of the present invention. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in data tables. A “key field” partitions the database according to the high-level class of objects defined by the key field. For example, a certain class may be designated as a key field in both the first data table and the second data table, and the two data tables may then be merged on the basis of the class data in the key field. In this exemplary embodiment, the data corresponding to the key field in each of the merged data tables is preferably the same. However, data tables having similar, though not identical, data in the key fields may also be merged by using AGREP, for example. Also, the association of XMI data is done using Document Type Definition (DTD) and schemas.

Communication between the various entities and the system of the present invention is accomplished through any suitable communication means, such as, for example, a telephone network, Intranet, Internet, point of interaction device (smart card system, point of sale device, personal digital assistant, cellular phone, kiosk, etc.), online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

Each entity may use a computing system to facilitate online commerce transactions. The user may use a computing unit in the form of a personal computer, although other types of computing units may be used including laptops, notebooks, hand held computers, set-top boxes, and the like. Communication system 501 may use a computing unit implemented in the form of a computer server, a computing center (e.g., a main frame computer), a minicomputer, a PC server, a network set of computers, and/or the like.

Optionally, a user computing unit, an communication system 501 computing system, and/or the like may be interconnected via a second network, such as a payment network. The payment network represents existing proprietary networks that presently accommodate transactions for credit cards, debit cards, and other types of financial/banking cards. The payment network is a closed network that is assumed to be secure from eavesdroppers. Examples of the payment network include the American Express®, VisaNet® and the Veriphone® network.

In the foregoing specification, the invention has been described with reference to specific embodiments. However, it will be appreciated that various modifications and changes can be made without departing from the scope of the present invention as set forth in the claims below. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented in the claims.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

What is claimed is:

1. A method for using a first financial instrument to facilitate access to a second financial instrument, comprising the steps of:
identifying a method of authentication for facilitating the activation of the first financial instrument;
verifying the method of authentication is valid for the first financial instrument;
using the first financial instrument to facilitate the verification that the method of authentication allows access to a second financial instrument; and
allowing access to the second financial instrument.

2. The method of claim 1,
wherein the first financial instrument includes at least one of a credit card, a smart card, a stored value card, a stored value product, a personal digital assistant, a cellular telephone, an electronic traveler's check, an on-line financial service, a radio frequency enabled payment device, and an automated teller machine; and
wherein the second financial instrument includes at least one of a credit card, a smart card, a stored value card, a stored value product, a personal digital assistant, a cellular telephone, an electronic traveler's check, an on-line financial service, a radio frequency enabled payment device, and an automated teller machine.

3. The method of claim 1, wherein the first financial instrument includes a smart card and the second financial instrument includes an on-line financial service, and further comprising the step of using the smart card to identify the method of authentication to include smart card and PIN for accessing the on-line financial service.

4. The method of claim 1, wherein the method of authentication includes at least one of user identification and password, a user identification and pass-phrase, biometrics, a smart card and PIN, a smart card and digital certificate, a palm pilot and digital certificate, sound verification, radio frequency and password, radio frequency and biometrics, infrared and biometrics, and infrared and password.

5. A method for using a first financial instrument to facilitate access to a second financial instrument, comprising the steps of:
identifying a method of authentication for facilitating the activation of the first financial instrument;
using the first financial instrument to facilitate the authentication of a user in connection with accessing a second financial instrument; and
allowing access to the second financial instrument based on the authentication of the user.

6. The method of claim 5:
wherein the first financial instrument includes at least one of a credit card, a smart card, a stored value card, a stored value product, a personal digital assistant, a cellular telephone, an electronic traveler's check, an on-line financial service, a radio frequency enabled payment device, and an automated teller machine;
wherein the second financial instrument includes at least one of a credit card, a smart card, a stored value card, a stored value product, a personal digital assistant, a cellular telephone, an electronic traveler's check, an on-line financial service, a radio frequency enabled payment device, and an automated teller machine; and
wherein the method of authentication includes at least one of user identification and password, a user identification and pass-phrase, biometrics, a smart card and PIN, a smart card and digital certificate, a palm pilot and digital certificate, sound verification, radio frequency and password, radio frequency and biometrics, infrared and biometrics, and infrared and password.

7. A method for facilitating the selection of one authentication method for accessing a plurality of financial instruments, comprising the steps of:
identifying an authentication method for facilitating access to a first financial instrument;
verifying that the authentication method can be used to facilitate access to a second financial instrument; and
using the authentication method to facilitate access to both the first and second financial instruments.

8. The method of claim 7, further comprising the steps of:
configuring the first financial instrument to include a smart card; and
configuring the second financial instrument to include a brokerage account, wherein the smart card may be used to access the brokerage account.

9. A method for using a first restricted service to facilitate authentication of a user in connection with accessing a second restricted service, comprising the steps of:
identifying a level of security for facilitating the authentication of a first restricted service;
verifying that the level of security for authentication of the first restricted service may be used to facilitate authentication of a second restricted service; and
using the authentication of the first restricted service to facilitate access to the second restricted service.

10. The method of claim 9, wherein the level of security for authentication includes at least one of user identification and password, a user identification and pass-phrase, biometrics, a smart card and PIN, a smart card and digital certificate, a palm pilot and digital certificate, sound verification, radio frequency and password, radio frequency and biometrics, infrared and biometrics, and infrared and password.

11. A method for using a first restricted service to facilitate the authentication of a user for accessing a second restricted service, comprising the steps of:
checking for a cookie residing on a user's computing unit, wherein a host reads the preference set in the cookie;
identifying the method of authentication of the first restricted service based on the preference set in the cookie;
selecting a minimum level of security for facilitating authentication of the first restricted service, if the preference set does not include information regarding the minimum level of security for authentication of the first restricted service; and
using the first restricted service to authenticate the user in connection with accessing the second restricted service using the minimum level of security for authentication.

12. A method for using a first financial instrument to facilitate access to a second financial instrument, comprising the steps of:
requesting data in connection with the first financial instrument via a web server;
receiving data in connection with the first financial instrument via the web server, wherein the data includes information regarding the authentication method for accessing the first financial instrument;
transmitting the data having information regarding the authentication method for the first financial instrument from the web server to a security server; and
using the first financial instrument to facilitate access to the second financial instrument by transmitting the data from the web server and the security server to an external security store via a communication channel and receiving data from the external security store via the communication channel.

13. A computer implemented method for using a first financial instrument to facilitate access to a second financial instrument, comprising the steps of:
obtaining data on the first financial instrument via a communication channel coupled to a computer system having a memory and a processor;
storing the data in the memory and using the processor to configure the data for allowing the first financial instrument to authenticate a user in connection with accessing the second financial instrument; and
allowing access to the second financial instrument upon using the first financial instrument to authenticate the user.

14. A communication system using a first financial instrument to facilitate access to a second financial instrument, comprising:
a host server for processing data in connection with a first financial instrument;
a database coupled to the host server for collecting data on the first financial instrument where the data includes information in connection with an authentication method for using the first financial instrument; and
a communication channel coupled between the host server, the database, the first financial instrument, and the second financial instrument for transmitting at least a portion of the data from the host server and the first financial instrument to the second financial instrument in order to authenticate the second financial instrument.

15. The communication system of claim 14,
wherein the first financial instrument includes at least one of a credit card, a smart card, a stored value card, a stored value product, a personal digital assistant, a cellular telephone, an electronic traveler's check, an on-line financial service, a radio frequency enabled payment device, and an automated teller machine,
wherein the second financial instrument includes at least one of a credit card, a smart card, a stored value card, a stored value product, a personal digital assistant, a cellular telephone, an electronic traveler's check, an on-line financial service, a radio frequency enabled payment device, and an automated teller machine; and
wherein the authentication method includes at least one of user identification and password, a user identification and pass-phrase, biometrics, a smart card and PIN, a smart card and digital certificate, a palm pilot and digital certificate, sound verification, radio frequency and password, radio frequency and biometrics, infrared and biometrics, and infrared and password.

16. A communication system using a first financial instrument to facilitate access to a second financial instrument, comprising:
a database for receiving data from the first financial instrument;
a processor coupled to the database for configuring the data in a format;
a communication channel in communication with the database and the processor for transmitting the data from the first financial instrument to the database and the processor, wherein the data includes a method of authentication for the first financial instrument; and
using the data to authenticate the second financial instrument upon transmitting the data to the database and processor.

17. The communication system of claim 16,
wherein the first financial instrument includes at least one of a credit card, a smart card, a stored value card, a stored value product, a personal digital assistant, a cellular telephone, an electronic traveler's check, an on-line financial service, a radio frequency enabled payment device, and an automated teller machine;
wherein the second financial instrument includes at least one of a credit card, a smart card, a stored value card, a stored value product, a personal digital assistant, a cellular telephone, an electronic traveler's check, an on-line financial service, a radio frequency enabled payment device, and an automated teller machine; and
wherein the method of authentication includes at least one of user identification and password, a user identification and pass-phrase, biometrics, a smart card and PIN, a smart card and digital certificate, a palm pilot and digital certificate, sound verification, radio frequency and password, radio frequency and biometrics, infrared and biometrics, and infrared and password.

18. A communication system using a first financial instrument to facilitate access to a second financial instrument, comprising:
a host server including a processor for processing data in connection with the first financial instrument;
a memory coupled to the processor for storing the data;
an input digitizer coupled to the memory and the processor for inputting the data into the memory; and
an application program stored in the memory and accessible by the processor for directing processing of the data by the processor, wherein the application program is configured to facilitate the steps of:
identify a method of authentication for activating the first financial instrument;
verify the method of authentication is valid for the first financial instrument;
use the first financial instrument to verify that the method of authentication allows access to a second financial instrument; and
allow access to the second financial instrument.

19. A communication system using a first financial instrument to facilitate access to a second financial instrument, comprising:
a browser for submitting data to a web server, wherein the browser and the web server communicate via a communication channel and the data submitted to the web server includes information in connection with the first financial instrument's minimum level of security for authentication;
a security server coupled to the web server via a second communication channel for retrieving data from the web server in connection with the minimum level of security for authentication; and
a database coupled to the security server via a third communication channel for receiving, storing, and submitting data to and from the security server, wherein the browser, web server, security server, and database communicate in order to authenticate the second financial instrument using the first financial instrument's minimum level of security for authentication.

20. The communication system of claim 19,
wherein the first financial instrument includes at least one of a credit card, a smart card, a stored value card, a stored value product, a personal digital assistant, a cellular telephone, an electronic traveler's check, an on-line financial service, a radio frequency enabled payment device, and an automated teller machine;
wherein the second financial instrument includes at least one of a credit card, a smart card, a stored value card, a stored value product, a personal digital assistant, a cellular telephone, an electronic traveler's check, an on-line financial service, a radio frequency enabled payment device, and an automated teller machine; and
wherein the minimum level of security for authentication includes at least one of user identification and password, a user identification and pass-phrase, biometrics, a smart card and PIN, a smart card and digital certificate, a palm pilot and digital certificate, sound verification, radio frequency and password, radio frequency and biometrics, infrared and biometrics, and infrared and password.
